(19) United States
(12) Patent Application Publication
(10) Pub. No.: US 2024/0395481 A1
(43) Pub. Date: Nov. 28, 2024

(54) KEYCAP AND MANUFACTURING METHOD THEREOF

(71) Applicant: Chicony Electronics Co., Ltd., New Taipei City (TW)

(72) Inventors: Ching-Wu Yang, New Taipei City (TW); Pai-Hsiang Wang, New Taipei City (TW)

(73) Assignee: Chicony Electronics Co., Ltd., New Taipei City (TW)

(21) Appl. No.: 18/475,166

(22) Filed: Sep. 26, 2023

(30) Foreign Application Priority Data
May 26, 2023 (TW) 112119697

(51) Int. Cl. H01H 13/83; H01H 13/88

(52) U.S. Cl. CPC H01H 13/83; H01H 13/88; H01H 2209/07; H01H 2209/082; H01H 2229/02; H01H 2229/058

(57) ABSTRACT

A keycap includes a keycap main body and multiple metal oxides. The metal oxides are doped in the keycap main body and forms an opaque region and a light-transmitting region in the keycap main body. The light-transmitting region is formed by irradiating a portion of the opaque region with an energy beam. A transmittancy of the light-transmitting region is greater than a transmittancy of the opaque region. A manufacturing method of the keycap is also disclosed.

### CROSS-REFERENCE TO RELATED APPLICATION

This application claims the priority benefit of Taiwan application serial no. 112119697, filed on May 26, 2023. The entirety of the above-mentioned patent application is hereby incorporated by reference herein and made a part of this specification.

### BACKGROUND

### Technical Field

The disclosure relates to a keycap, and more particularly, to a light-transmitting keycap

### Description of Related Art

In a manufacturing process of keycaps of general backlit keyboards, it is necessary to spray light-transmitting plastic keycaps with black paint, engrave characters or graphic symbols through laser engraving on the black paint to enable light sources in the keyboard to show the luminous characters or graphic symbols through the keycaps, and finally coat a light curing adhesive on surfaces of the keycaps as character layers. The manufacturing process is tedious and lengthy.

### SUMMARY

The disclosure provides a keycap and a manufacturing method thereof, which may save time for manufacturing the key cap.

A keycap in the disclosure includes a keycap main body and multiple metal oxides. The metal oxides are doped in the keycap main body and forms an opaque region and a light-transmitting region in the keycap main body. The light-transmitting region is formed by irradiating a portion of the opaque region with an energy beam. A transmittancy of the light-transmitting region is greater than a transmittancy of the opaque region.

In an embodiment of the disclosure, the keycap main body includes a plastic substrate, and the metal oxides are doped in the plastic substrate.

In an embodiment of the disclosure, the light-transmitting region includes multiple sub-light-transmitting regions, and the sub-light-transmitting regions have different transmittancies.

In an embodiment of the disclosure, a material of a plastic substrate includes acrylonitrile-butadiene-styrene, polycarbonate, polybutylene terephthalate, or a combination of acrylonitrile-butadiene-styrene and polycarbonate.

In an embodiment of the disclosure, an average particle size of the metal oxides is between 1 nm and 100 μm.

In an embodiment of the disclosure, the metal oxides include ferric oxide.

Another keycap in the disclosure includes a keycap main body, multiple metal oxides, and a character layer. The character layer is disposed on an outer surface of the keycap main body. The metal oxides are doped in the character layer. The character layer includes an opaque region and a light-transmitting region. The light-transmitting region is formed by irradiating a portion of the opaque region with an energy beam. A transmittancy of the light-transmitting region is greater than a transmittancy of the opaque region. A shape of the light-transmitting region is a character or a graphic.

In an embodiment of the disclosure, the character layer includes a light curing layer.

In an embodiment of the disclosure, the character layer includes ink.

In an embodiment of the disclosure, the light-transmitting region has a thickness to cover the keycap main body.

In an embodiment of the disclosure, the light-transmitting region has the transmittancy of more than 20%.

Another keycap in the disclosure includes a keycap main body, multiple metal oxides, and a membrane sheet. The membrane sheet includes an opaque region and a light-transmitting region. The light-transmitting region is formed by irradiating a portion of the opaque region with an energy beam. A transmittancy of the light-transmitting region is greater than a transmittancy of the opaque region. A shape of the light-transmitting region is a character or a graphic.

A manufacturing method of a keycap in the disclosure includes the following. A keycap main body and multiple metal oxides are provided. The metal oxides are doped in the keycap main body. By irradiating a portion of the keycap main body with an energy beam, a portion of the metal oxides is transformed into a light-transmitting region. Another portion of the metal oxides forms an opaque region in the keycap main body, and a shape of the light-transmitting region is a character or a graphic.

In an embodiment of the disclosure, the keycap main body includes a plastic substrate, and the method further includes the following. The metal oxides are doped in the plastic substrate.

In an embodiment of the disclosure, the keycap main body includes a plastic substrate and a character layer, and the method further includes the following. The metal oxides are doped in a character layer material. The character layer material is coated on an outer surface of the plastic substrate to form the character layer.

In an embodiment of the disclosure, the character layer material includes a light curing layer.

In an embodiment of the disclosure, the keycap main body includes a plastic substrate and a membrane sheet, and the method further includes the following. The metal oxides are doped in the membrane sheet. The membrane sheet is disposed on an outer surface of the plastic substrate.

In an embodiment of the disclosure, the energy beam includes a laser beam, and a step of irradiating the portion of the keycap main body with the energy beam includes the following. Different positions of the portion of the keycap main body are respectively irradiated with multiple laser beams having different wavelengths, different irradiation time, or a combination thereof, so that the light-transmitting region includes multiple sub-light-transmitting regions, and the sub-light-transmitting regions have different transmittancies respectively.

In an embodiment of the disclosure, a material of a plastic substrate includes acrylonitrile-butadiene-styrene, polycarbonate, polybutylene terephthalate, or a combination of acrylonitrile-butadiene-styrene and polycarbonate.

In an embodiment of the disclosure, an average particle size of the metal oxides is between 1 nm and 100 μm.

In an embodiment of the disclosure, the metal oxides include ferric oxide.

In an embodiment of the disclosure, the energy beam includes a laser beam, and a step of irradiating the portion of the keycap main body with the energy beam includes the following. The portion of the keycap main body is irradiated with the laser beam with a wavelength range between 150 nm and 380 nm.

Based on the above, in the keycap of the disclosure, the metal oxides are doped in the keycap main body to form the opaque region and the light-transmitting region in the keycap main body. In this way, it is not necessary to spray the paint on the keycap main body first and then perform the laser engraving on the paint layer, so that the light emitting member in the keyboard may show the luminous characters or graphic symbols through the light-transmitting region of the keycap. Therefore, the process time of the keycap is effectively saved.

### BRIEF DESCRIPTION OF THE DRAWINGS

FIG. 1 is a schematic view of a keycap according to an embodiment of the disclosure.

FIG. 2 is a schematic view of a keycap according to another embodiment of the disclosure.

FIG. 3 is a schematic view of a keycap according to another embodiment of the disclosure.

FIG. 4 is a flowchart of a manufacturing method of the keycap in FIG. 1.

FIGS. 5A and 5B are specific flowcharts of the manufacturing method of the keycap in FIG. 1.

FIGS. 6A to 6D are specific flowcharts of a manufacturing method of the keycap in FIG. 2.

FIG. 7 is a specific flowchart of a manufacturing method of the keycap in FIG. 3.

FIG. 8 is a schematic top view of a keycap according to another embodiment of the disclosure.

### DETAILED DESCRIPTION OF DISCLOSED EMBODIMENTS

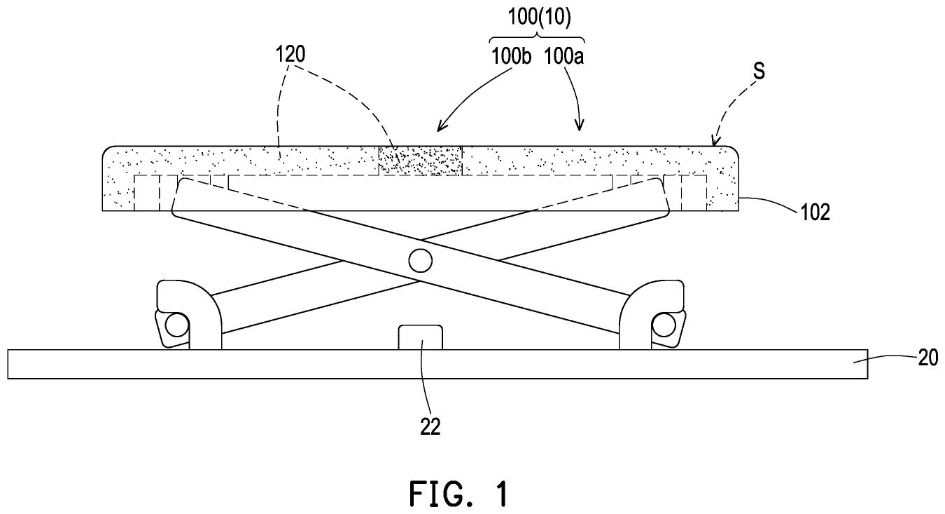

FIG. 1 is a schematic view of a keycap according to an embodiment of the disclosure. Referring to FIG. 1, a keycap 10 in this embodiment is, for example, a keycap of one of keys of a backlit keyboard, but an application field of the keycap 10 is not limited thereto. The keycap 10 is disposed above a base plate 20 and includes a keycap main body 100 and multiple metal oxides 120. The metal oxides 120 are doped in the keycap main body 100 and forms an opaque region 100a and a light-transmitting region 100b in the keycap main body 100. The light-transmitting region 100b is, for example, in a shape of a character or a graphic symbol, and a transmittancy generated by a plastic substrate changes when the plastic substrate is irradiated by an energy beam to form a specific character or graphic. However, the disclosure is not limited thereto. In some embodiments, a configuration may also be reversed (the opaque region is a text symbol). That is to say, some of the metal oxides 120 in the keycap main body 100 will change the transmittancy after being irradiated by the energy beam, thereby forming the light-transmitting region 100b, while the region not irradiated by the energy beam forms the opaque region 100a.

In detail, the keycap main body 100 is processed by plastic mixed with the metal oxides 120. Before being irradiated by the energy beam, the metal oxides 120 in the keycap main body 100 are evenly distributed in the keycap main body 100, and the keycap main body 100 presents an opaque state. Changes in the transmittancy are generated by irradiating some of the metal oxides 120 with the energy beam such as a laser beam. In this way, the good light-transmitting region 100b and opaque region 100a are formed in the keycap main body 100, so that a light emitting member 22 (for example, a light emitting diode (LED), an incandescent lamp, or a halogen lamp) disposed on the base plate 20 emits light through the light-transmitting region 100b of the keycap main body 100 to display the character or the graphic symbol in the light-transmitting region 100b, and the opaque region 100a may block the light of the light emitting member 22 to avoid light leakage. Since the keycap main body 100 in the disclosure forms the opaque region 100a and the light-transmitting region 100b by doping the metal oxides 120 and irradiating with the energy beam, it is not necessary to spray paint on the keycap main body 100 and then perform laser engraving to remove paint layers in some regions to form the character, and it is not necessary to dispose a protective paint layer above the character to avoid wear of the character, thereby effectively saving a material of the keycap, a manufacturing process, and time. Technical content in the embodiments of the disclosure will be described in more detail in the following.

The keycap main body 100 in this embodiment includes a plastic substrate 102. A material of the plastic substrate is, for example, ABS (acrylonitrile butadiene styrene), PC (polycarbonate), PBT (polybutylene terephthalate), or a combination of ABS and PC, and the metal oxides 120 are evenly doped in the plastic substrate 102. An average particle size of the metal oxide 120 is between 1 nm and 100 μm. In terms of components, the metal oxides 120, for example, include ferric oxide (Fe2O3), etc., and a weight percentage (wt %) of the metal oxides 120 in the keycap main body 100 is between 0.1% and 20%. When the weight percentage of the metal oxide 120 in the keycap main body 100 is higher, the keycap main body 100 is in a darker color. On the contrary, the keycap main body 100 is in a lighter color.

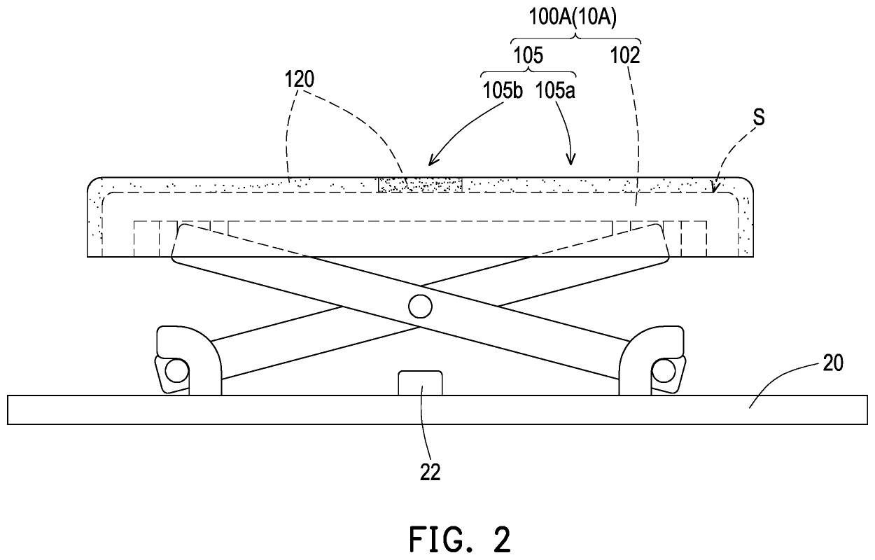

FIG. 2 is a schematic view of a keycap according to another embodiment of the disclosure. A difference between the embodiment shown in FIG. 2 and the embodiment shown in FIG. 1 is that the plastic substrate 102 is not doped with the metal oxides. In detail, a keycap 10A includes a keycap main body 100A, the metal oxides 120, and a character layer 105. The keycap main body 100A includes a light-transmitting substrate. Preferably, in this embodiment, the keycap main body 100A is formed by the plastic substrate 102, but the disclosure is not limited thereto. The character layer 105 covers an outer surface S of the plastic substrate 102, and the metal oxides 120 is doped in the character layer 105.

In detail, the metal oxides 120 are uniformly mixed in a liquid carrier, and the weight percentage (%) of the metal oxides 120 in the liquid carrier is between 0.1% and 20%. The character layer 105 is formed by spraying the liquid carrier on the outer surface S of the keycap main body 100A, and the entire character layer 105 is in the opaque state. The changes in the transmittancy are generated by irradiating a portion of the character layer 105 with the energy beam. Further, the metal oxides 120 form an opaque region 105a and a light-transmitting region 105b in the character layer 105. The light-transmitting region 105b is, for example, in the shape of the character or the graphic symbol, and the light emitting member 22 of the base plate 20 shows the luminous character or graphic symbol through the light-transmitting region 105b, so as to achieve a backlight effect of the keycap 10A. In this embodiment, the light-transmitting region 105b has a transmittancy of more than 20%. In another embodiment, the light emitting member is, for example, a backlight module. The backlight module includes a light guide plate and a light source such as the light emitting diode (LED). The backlight module is disposed below the base plate 20. Light emitted by the backlight module may pass through and irradiate the light-transmitting region 105b of the keycap 10A, and the transmittancy of the light-transmitting region 105b may also be adjusted according to actual lighting requirements. The disclosure is not limited thereto.

A material of the character layer 105 in this embodiment is, for example, a light curing layer or ink. Formation of the light curing layer is that light curing paint (UV paint), UV adhesive, or UV resin ink is coated on the outer surface S of the keycap main body 100A, and cured after being irradiated with ultraviolet light (for example, using a UV lamp), so as to cover and protect the outer surface S of the keycap main body 100A and have good hardness. In this way, the character layer 105 in this embodiment improves surface strength of the keycap main body 100A, which may prevent the keycap 10A from being worn out under long-term operation, thereby increasing a service life of the keycap 10A. In detail, after the outer surface S of the keycap main body 100A is sprayed with the light curing paint, it is first irradiated with the ultraviolet light to cure the character layer 105 into the light curing layer, and then a laser process is performed. Details of the laser process will be further described in the following.

In addition, in another embodiment, the keycap 10A includes a keycap main body 100A and a membrane sheet. The metal oxides 120 are doped in the membrane sheet. The membrane sheet may be formed in a manner of injection molding, thermal transfer film, or coating the membrane sheet. The membrane sheet is pasted or coated on the outer surface S of the keycap main body 100A, then the UV lamp is applied to cure the membrane sheet, and a region of the membrane sheet is irradiated by the energy beam to form the light-transmitting region 105b, while the region not irradiated by the energy beam forms the opaque region 105a. The transmittancy of the light-transmitting region is greater than that of the opaque region, and a shape of the light-transmitting region is the character or graphics.

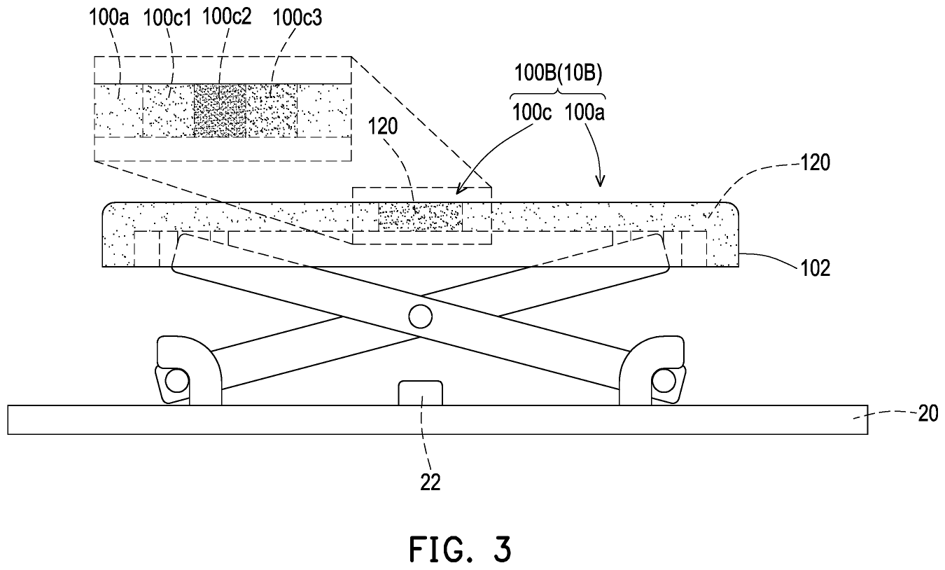

FIG. 3 is a schematic view of a keycap according to another embodiment of the disclosure. A difference between the embodiment shown in FIG. 3 and the embodiment shown in FIG. 1 is that a light-transmitting region 100c of a keycap main body 100B in FIG. 3 includes multiple sub-light-transmitting regions, and sub-light-transmitting regions 100c1, 100c2, and 100c3 have different transmittancies respectively. When the light of the light emitting member 22 is irradiated through the sub-light-transmitting regions 100c1, 100c2, 100c3, a visual effect of gradual changes in the light may be presented, thereby enhancing appearance aesthetics of a keycap 10B.

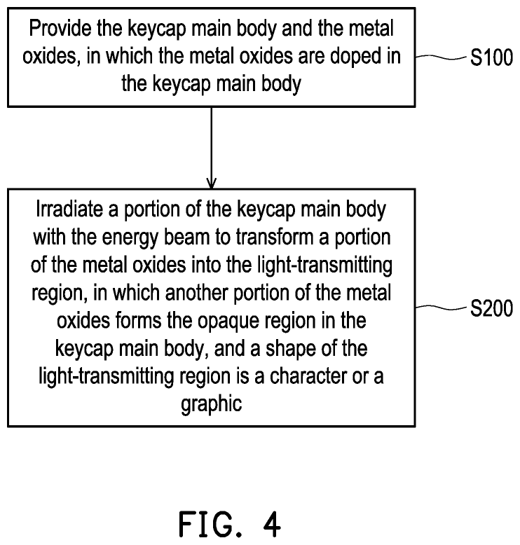

A manufacturing method of the keycap according to the embodiment of the disclosure will be described in the following. FIG. 4 is a flowchart of a manufacturing method of the keycap in FIG. 1. Referring to FIGS. 1 and 4, first, the keycap main body 100 and the metal oxides 120 are provided. The metal oxides 120 are doped in the keycap main body 100 (step S100). Next, a portion of the keycap main body 100 is irradiated with the energy beam to transform a portion of the metal oxides 120 into the light-transmitting region 100b. Another portion of the metal oxides 120 forms the opaque region 100a in the keycap main body 100 (step S200).

In step S200, the energy beam is, for example, the laser beam, and a wavelength thereof is preferably in an infrared wavelength range (780 nm to 3000 nm), a visible light wavelength range (380 nm to 780 nm), or an ultraviolet wavelength range (100 nm to 380 nm). Types of lasers include but are not limited to solid state pulsed lasers, pulsed metal vapor lasers, excimer lasers, and continuous wave lasers with pulse adjustment, such as existing carbon dioxide lasers or Nd:YAG lasers (e.g., a wavelength of 1064 nm), frequency-doubled Nd:YAG lasers (e.g., a wavelength of 532 nm), or excimer lasers (e.g., a wavelength of 193 nm to 351 nm). The portion of the keycap main body 100 is irradiated with the laser beam having a wavelength range of 150 nm to 380 nm, for example, which may enable the keycap main body 100 to obtain a better light-transmitting effect. However, a type of the wavelength is not limited thereto.

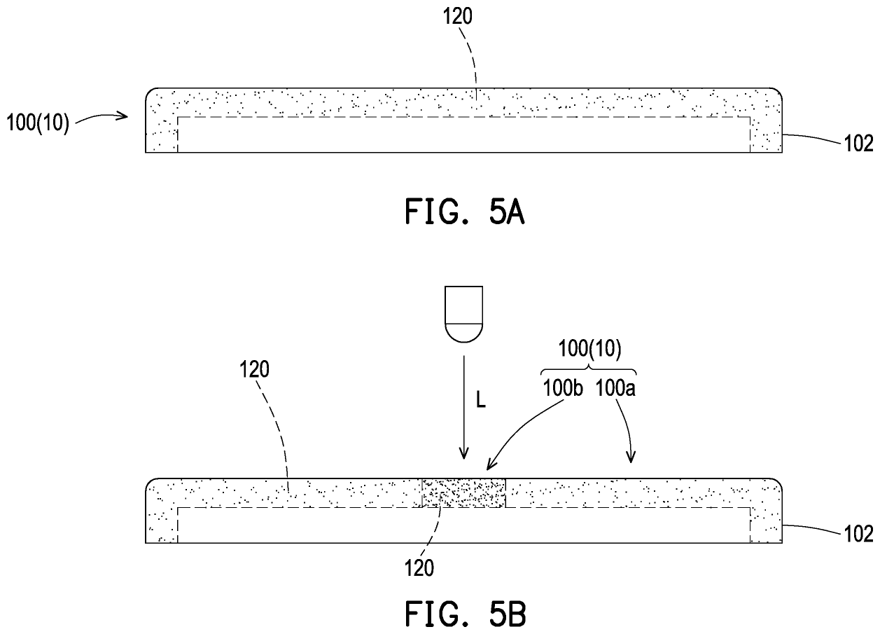

Hereinafter, a specific manufacturing process of the keycap in the embodiment shown in FIG. 1 is described in more detail. FIGS. 5A and 5B are specific flowcharts of the manufacturing method of the keycap in FIG. 1. First, as shown in FIG. 5A, the metal oxides 120 are uniformly doped in the plastic substrate 102. In detail, plastic used to manufacture the plastic substrate 102 may be fully stirred and mixed with the metal oxides 120 first to be formed into a plastic pellet material through a plastic pellet process, and finally perform the injection molding on the plastic pellet material, so as to manufacture the plastic substrate 102 doped with the metal oxides 120 to serve as the keycap main body 100 of the keycap 10. However, the disclosure does not limit a forming method of the keycap main body 100.

Next, as shown in FIG. 5B, an energy beam L is irradiated on a portion of the plastic substrate 102 doped with the metal oxides 120 to form the light-transmitting region 100b in the keycap main body 100. The light of the light emitting member 22 (FIG. 1) may be irradiated through the light-transmitting region 100b of the keycap main body 100, so as to achieve a light emitting effect of the keycap 10. On the other hand, the another portion of the metal oxides 120 (i.e., the portion not irradiated by the energy beam L) forms the opaque region 100a in the keycap main body 100. Since the metal oxides 120 in the opaque region 100a are not irradiated by the energy beam L and maintain the original opaque state, the light of the light emitting member 22 may be blocked to avoid the light leakage. Through the manufacturing process, the good light-transmitting region 100b and opaque region 100a may be formed in the plastic substrate 102.

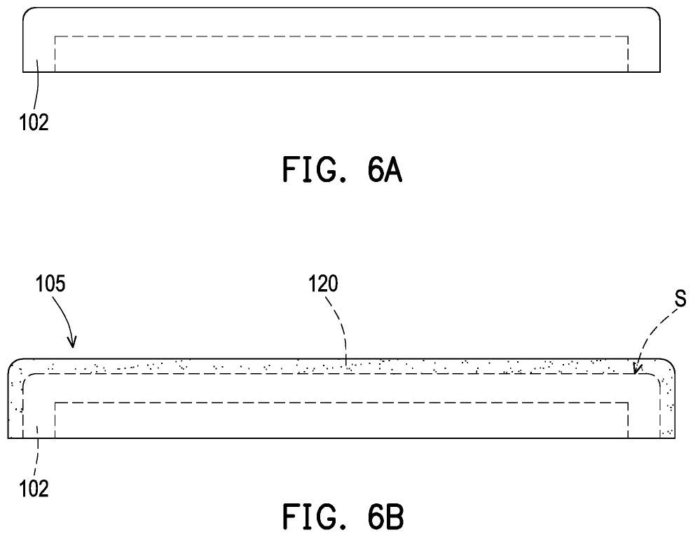

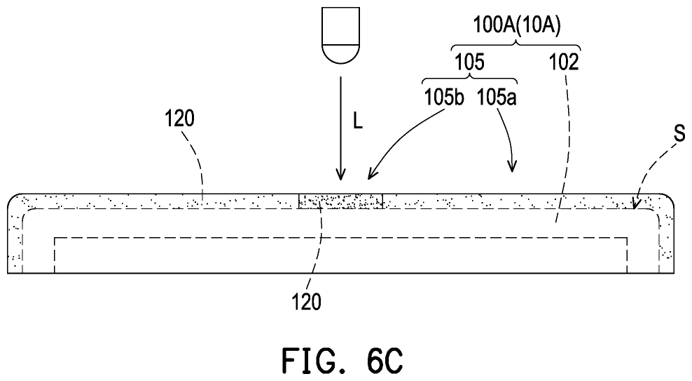

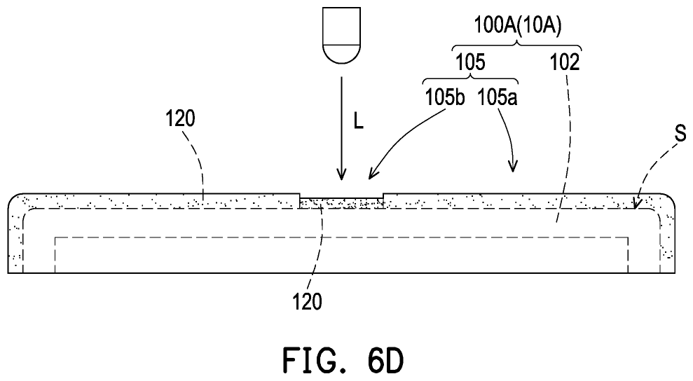

Hereinafter, a specific manufacturing process of the keycap in the embodiment shown in FIG. 2 is described in more detail. FIGS. 6A to 6D are specific flowcharts of a manufacturing method of the keycap in FIG. 2. First, as shown in FIG. 6A, the plastic substrate 102 is provided. The plastic substrate 102 may be formed by the injection molding. Next, as shown in FIG. 6B, firstly, the metal oxides 120 are doped into a character layer material. The character layer material includes, for example, the light curing layer, and the light curing layer may be the UV paint, the UV adhesive, or the UV resin ink. Then, the character layer material is coated on the outer surface S of the plastic substrate 102 not doped with the metal oxides, and cured after being irradiated with the ultraviolet light (such as the UV lamp) to form the character layer 105.

Next, as shown in FIG. 6C, the energy beam L irradiates the portion of the character layer 105 to change a transmittancy of the metal oxides 120 in this region to form the light-transmitting region 105b. On the other hand, the metal oxides 120 in the region of the character layer 105 not irradiated by the energy beam L maintain the original opaque state to form the opaque region 105a.

In this embodiment, the light-transmitting region 105b is formed by irradiating the character layer 105 with the energy beam. That is, the irradiation of the energy beam may change the transmittancy of the metal oxides 120 to form light-transmitting patterns or characters on the character layer 105. The light-transmitting region 105b has the higher transmittancy than the opaque region 105a not irradiated by the energy beam. It should also be noted that, before not irradiated by the energy beam, the character layer 105 as a whole is the opaque region 105a, and the light-transmitting region 105b is formed by irradiating a portion of the opaque region with the energy beam, while the portion of the character layer 105 not irradiated by the energy beam remains as the opaque region 105a. That is, a size of the opaque region 105a changes due to the irradiation of the energy beam.

The light-transmitting region in this embodiment is formed by the irradiation of the energy beam. As shown in FIG. 6D, due to wavelength energy of the energy beam, there is a slight loss on a surface of the light-transmitting region 105b, so that a thickness of the light-transmitting region 105b is slightly lower than a thickness of the opaque region 105a. The light-transmitting region still has a thickness on the keycap main body. In an existing luminous keycap, a surface of the keycap is coated with the paint layer, and a portion of the paint layer is removed to expose a light-transmitting substrate of the keycap to form hollowed characters or patterns, so that light passes through the hollowed characters or patterns on the keycap to emit the light. In contrast, a surface of the character layer 105 in this embodiment has a thickness, so the keycap has good wear resistance.

In addition, the light-transmitting region 105b irradiated by the energy beam has a thickness to cover the plastic substrate 102. The light emitted by the light emitting member 22 directly passes through the light-transmitting region 105b of the character layer 105, so that the light-transmitting region 105b may achieve the light emitting effect, and no additional light-transmitting coating is required on the character layer 105.

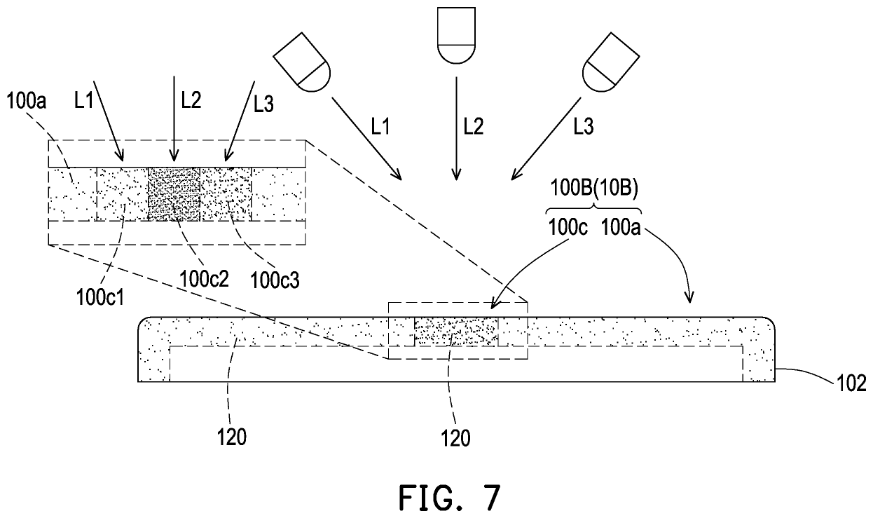

Hereinafter, a specific manufacturing process of the keycap in the embodiment shown in FIG. 3 is described in more detail. FIG. 7 is a specific flowchart of a manufacturing method of the keycap in FIG. 3. First, the metal oxides 120 are doped in the keycap main body 100B according to the steps described in FIG. 5A. Next, as shown in FIG. 7, multiple laser beams L1, L2, L3 with different wavelength energy, different irradiation time, or a combination thereof are respectively irradiated to different positions of a portion of the keycap main body 100B, thereby forming the sub-light-transmitting regions 100c1, 100c2, 100c3 in the keycap main body 100B. the sub-light-transmitting regions 100c1, 100c2, and 100c3 have different transmittancies respectively.

In some embodiments, the single laser beam with a fixed wavelength energy may be irradiated on the keycap main body 100B according to different numbers of times, for example, one to five times, to form the sub-light-transmitting regions in the keycap main body 100B, so that the sub-light-transmitting regions have different transmittancies.

After some of the metal oxides 120 change the transmittancy as mentioned above, the light-transmitting region 100c is formed in the keycap main body 100. Since the energy beams L1, L2, and L3 have different wavelengths, the energy beams L1, L2, and L3 may react to the light-transmitting region 100c in different degrees to form the sub-light-transmitting regions 100c1, 100c2, and 100c3 with different transmittancies. The sub-light-transmitting region 100c1 corresponds to the energy beam L1, for example. The sub-light-transmitting region 100c2 corresponds to the energy beam L2, for example. The sub-light-transmitting region 100c3 corresponds to the energy beam L3, for example. In this way, when the light of the light emitting member 22 (FIG. 3) passes through the sub-light-transmitting regions 100c1, 100c2, 100c3, the visual effect of the gradual changes in the light may be presented, thereby enhancing the appearance aesthetics of the keycap 10B.

In the example shown in FIG. 7, the energy beams and the sub-light-transmitting regions are respectively shown as three, but the number of energy beams and the number of sub-light-transmitting regions may be adjusted according to actual design requirements, and the disclosure is not limited thereto.

It should also be noted that, for clarity in the drawings, the metal oxides in FIGS. 1, 2, 3, and 5A to 7 in the disclosure are schematically shown as irregular dots, but it is not intended to limit the size and distribution of the metal oxides.

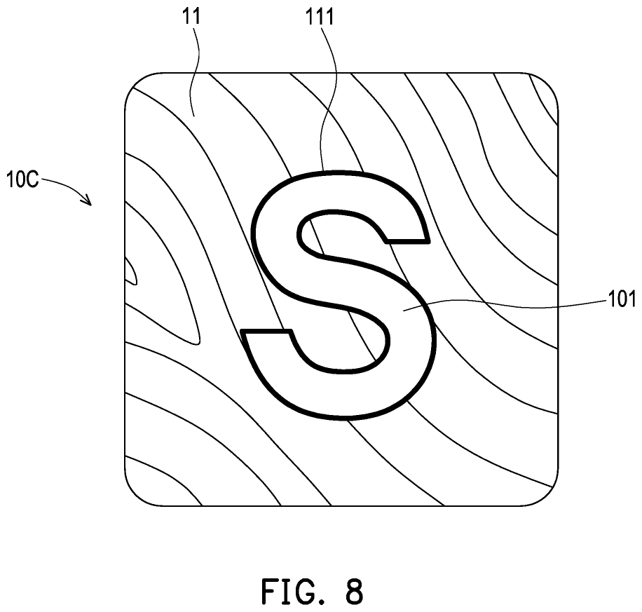

FIG. 8 is a schematic top view of a keycap according to another embodiment of the disclosure. Referring to FIG. 8, in a manufacturing process of a keycap 10C in this embodiment, a shield layer 11 may be coated outside a character of the keycap 10C (that is, a region outside a boundary 111 of a S-shaped character in FIG. 8). A material of the shield layer 11 is, for example, colored paint or dark ink. The shield layer 11 is configured to define a character range (that is, a light-transmitting region 101) to limit an irradiation region of the energy beam, and after being irradiated by the energy beam, it may ensure that the light-transmitting region 101 may well show light-transmitting characters or graphics.

Based on the above, in the keycap of the disclosure, the metal oxides are doped in the keycap main body to form the opaque region in the keycap main body, and the metal oxides are doped in the keycap main body and to form the light-transmitting region in the keycap main body after being irradiated by laser. In this way, it is not necessary to spray the paint on the keycap main body first and then perform the laser engraving on the paint layer, so that the light emitting member in the keyboard may show the luminous characters or graphic symbols through the light-transmitting region of the keycap. Therefore, the process time of the keycap is effectively saved. The existing luminous keycaps are hollowed out by the laser engraving and are required to be coated with the multi-layer structure. In contrast, in the disclosure, not only the processing time and cost may be reduced, but also the influence on the processing of the plastic keycap is small, and the structure of the keycap main body is not easy to be damaged. In addition, if the energy beams with different wavelengths are used to irradiate different positions of the light-transmitting region of the keycap main body, the sub-light-transmitting regions with different transmittancies may be formed correspondingly, thereby achieving the visual effect of the gradual changes in the light and enhancing the appearance aesthetics of the keycap.

What is claimed is:

1. A keycap, comprising:
a keycap main body; and
a plurality of metal oxides, wherein the metal oxides are doped in the keycap main body and forms an opaque region and a light-transmitting region in the keycap main body, the light-transmitting region is formed by irradiating a portion of the opaque region with an energy beam, and a transmittancy of the light-transmitting region is greater than a transmittancy of the opaque region.

2. The keycap according to claim 1, wherein the keycap main body comprises a plastic substrate, and the metal oxides are doped in the plastic substrate.

3. The keycap according to claim 1, wherein the light-transmitting region comprises a plurality of sub-light-transmitting regions, and the sub-light-transmitting regions have different transmittancies.

4. The keycap according to claim 1, wherein a material of a plastic substrate comprises acrylonitrile-butadiene-styrene, polycarbonate, polybutylene terephthalate, or a combination of acrylonitrile-butadiene-styrene and polycarbonate.

5. The keycap according to claim 1, wherein an average particle size of the metal oxides is between 1 nm and 100 μm.

6. The keycap according to claim 1, wherein the metal oxides comprise ferric oxide.

7. A keycap, comprising:
a keycap main body;
a plurality of metal oxides; and
a character layer disposed on an outer surface of the keycap main body, wherein the metal oxides are doped in the character layer, the character layer comprises an opaque region and a light-transmitting region, the light-transmitting region is formed by irradiating a portion of the opaque region with an energy beam, and a transmittancy of the light-transmitting region is greater than a transmittancy of the opaque region, and a shape of the light-transmitting region is a character or a graphic.

8. The keycap according to claim 7, wherein the character layer comprises a light curing layer.

9. The keycap according to claim 7, wherein the character layer comprises ink.

10. The keycap according to claim 7, wherein the light-transmitting region has a thickness to cover the keycap main body.

11. The keycap according to claim 7, wherein the light-transmitting region has the transmittancy of more than 20%.

12. A keycap, comprising:
a keycap main body;
a plurality of metal oxides; and
a membrane sheet disposed on an outer surface of the keycap main body, wherein the metal oxides are doped in the membrane sheet, the membrane sheet comprises an opaque region and a light-transmitting region, the light-transmitting region is formed by irradiating a portion of the opaque region with an energy beam, and a transmittancy of the light-transmitting region is greater than a transmittancy of the opaque region, and a shape of the light-transmitting region is a character or a graphic.

13. The keycap according to claim 12, wherein the membrane sheet is pasted or covered on the outer surface of the keycap main body.

14. The keycap according to claim 12, wherein the membrane sheet is formed by injection molding, thermal transfer film, or coating the membrane sheet.

15. A manufacturing method of a keycap, comprising:
providing a keycap main body and a plurality of metal oxides, wherein the metal oxides are doped in the keycap main body; and
by irradiating a portion of the keycap main body with an energy beam, transforming a portion of the metal oxides into a light-transmitting region,
wherein another portion of the metal oxides forms an opaque region in the keycap main body, and a shape of the light-transmitting region is a character or a graphic.

16. The manufacturing method of the keycap according to claim 15, wherein the keycap main body comprises a plastic substrate, and the method comprises:
doping the metal oxides in the plastic substrate.

17. The manufacturing method of the keycap according to claim 15, wherein the keycap main body comprises a plastic substrate and a character layer, and the method comprises:
doping the metal oxides in a character layer material; and
coating the character layer material on an outer surface of the plastic substrate to form the character layer.

18. The manufacturing method of the keycap according to claim 17, wherein the character layer material comprises a light curing layer.

19. The manufacturing method of the keycap according to claim 15, wherein the keycap main body comprises a plastic substrate and a membrane sheet, and the method comprises:
doping the metal oxides in the membrane sheet; and
disposing the membrane sheet on an outer surface of the plastic substrate.

20. The manufacturing method of the keycap according to claim 15, wherein the energy beam comprises a laser beam, and a step of irradiating the portion of the keycap main body with the energy beam comprises:
respectively irradiating different positions of the portion of the keycap main body with a plurality of laser beams having different wavelengths, different irradiation time, or a combination thereof, so that the light-transmitting region comprises a plurality of sub-light-transmitting regions, and the sub-light-transmitting regions have different transmittancies respectively.

21. The manufacturing method of the keycap according to claim 15, wherein a material of a plastic substrate comprises acrylonitrile-butadiene-styrene, polycarbonate, polybutylene terephthalate, or a combination of acrylonitrile-butadiene-styrene and polycarbonate.

22. The manufacturing method of the keycap according to claim 15, wherein an average particle size of the metal oxides is between 1 nm and 100 μm.

23. The manufacturing method of the keycap according to claim 15, wherein the metal oxides comprise ferric oxide.

24. The manufacturing method of the keycap according to claim 15, wherein the energy beam comprises a laser beam, and a step of irradiating the portion of the keycap main body with the energy beam comprises:
irradiating the portion of the keycap main body with the laser beam with a wavelength range between 150 nm and 380 nm.
